(19) United States
(12) Patent Application Publication
(10) Pub. No.: US 2026/0211244 A1
(43) Pub. Date: Jul. 23, 2026

(54) SPECTACLE LENS FOR A HEAD-MOUNTED DISPLAY, HEAD-MOUNTED DISPLAY AND METHOD FOR DESIGNING AND MANUFACTURING A SPECTACLE LENS

(71) Applicant: tooz technologies GmbH, Aalen (DE)

(72) Inventors: Andrea Berner, Jena (DE); Holger Muenz, Aalen (DE); Jan Mathis Kaster, Heubach (DE)

(73) Assignee: tooz technologies GmbH, Aalen (DE)

(21) Appl. No.: 19/568,433

(22) Filed: Mar. 16, 2026

Related U.S. Application Data
(63) Continuation of application No. PCT/EP2024/075500, filed on Sep. 12, 2024.

(30) Foreign Application Priority Data
Sep. 18, 2023 (DE) 102023125130.9

(51) Int. Cl. G02B 27/01; G02C 7/02

(52) U.S. Cl. CPC G02B 27/0172; G02B 27/0101; G02C 7/022; G02C 7/024; G02B 2027/011; G02B 2027/0132; G02B 2027/0178; G02C 2202/16

(57) ABSTRACT

A spectacle lens for a head-mounted display includes a first lens element, a second lens element, and a waveguide. The first and the second lens elements have curved surfaces. The waveguide is arranged in such a way between the first lens element and the second lens element that the first lens-element surface and the second lens-element surface face away from the waveguide. From the inside to the outside, the curvature of one of the two lens-element surfaces changes from concave to convex at least in portions, and, from the inside to the outside, the curvature of the other of the two lens-element surfaces changes from convex to concave at least in portions. Further, a head-mounted display, a method for designing a spectacle lens, a data processing system, a computer program, a data set containing data for describing a spectacle lens, and a method for producing a spectacle lens are disclosed.

### CROSS REFERENCE TO RELATED PATENT APPLICATIONS

This application is a continuation application of international patent application PCT/EP2024/075500, filed on Sep. 12, 2024, and designating the U.S., which claims priority to German patent application DE 102023125130.9, filed on Sep. 18, 2023, both of which are hereby incorporated by reference in their entireties.

### FIELD OF DISCLOSURE

The disclosure relates to a spectacle lens for a head-mounted display, a head-mounted display, a computer-implemented method for designing a spectacle lens, a data processing system, a computer program, a data set containing data for describing a spectacle lens, and a method for producing a spectacle lens.

### BACKGROUND

In ophthalmic optics, the weight and thickness of high-diopter spectacle lenses in particular can be reduced by providing a carrier edge, as described in the section 5.5.2 “Gewichtsreduktion [weight reduction]” of LACHENMAYR, B., FRIEDBURG, D., BUSER, A.: “Auge—Brille—Refraktion,” 5th edition, pages 129 to 130, Thieme, 2016. Corresponding spectacle lenses are also referred to as lenticular lenses.

In conventional lenticular lenses—both in the minus range and in the plus range—the optically corrected region, which may be circular or matched to the shape of the spectacles, transitions abruptly into the carrier edge. This leads to a sudden change in the dioptric power at the optical separating line, possibly resulting in a ring-shaped gap, known as a ring or annular scotoma, in the spectacle wearer's field of view, and this may significantly impair the wearer's ability to orient themselves in space.

To prevent such annular scotomas, it is possible to create a continuous transition zone between the optically corrected region and the carrier edge by virtue of the dioptric power changing continuously in the transition zone between the optically corrected region and the edge of the spectacle lens. Such spectacle lenses are also referred to as aspheric lenticular spectacle lenses and offer the advantage of the spectacle wearer being able to see the entire field of view (FOV) and orient themselves without restrictions in space. Although such a spectacle lens is annular-scotoma-free, there are significant aberrations in transmission and reflection in the edge region, for example a significant astigmatism.

Furthermore, waveguide-based monocular or binocular headsets, also referred to as head-mounted displays, are known from the related art. Head-mounted displays, for example in the form of smartglasses or AR (augmented reality) headsets or VR (virtual reality) headsets or MR (mixed reality) headsets or VR or MR glasses or VR or MR helmets, are used in numerous contexts. A head-mounted display can allow electronically created images to be combined with the image of the surroundings as perceived directly by the user. In this case, the light associated with the electronically created image is input coupled between the inner surface and the outer surface of a waveguide by means of an input coupling portion and subsequently guided in the waveguide by exploiting total-internal reflection. The beam path of the electronically created image is combined with the direct image from the surroundings with the aid of an output coupling portion which serves to output couple the beam path of the electronically created image in the direction of the eye. For this purpose, the output coupling portion is arranged on the waveguide. Directly after being output coupled, the output-coupled light passes through a possibly present spectacle lens element, e.g., a so-called pull lens, which is either directly coupled to the waveguide, e.g., by means of an adhesive or the like, or separated from the waveguide by a narrow air gap.

The design and production of head-mounted displays capable of displaying a full-color image or text for the wearer have already been described comprehensively in patent literature.

Head-mounted displays may comprise a waveguide and one or more additional lens elements, for example so-called push and/or pull lenses, per eye, as illustrated in FIG. 1.

These one or more lens elements may serve to 1) correct the ametropia of the eye, i.e., a refractive error that is caused by a refraction anomaly and/or an axial length change of the eye, and/or 2) let the focus of the virtual image appear at a desired distance (pull lens) without the image of the real surroundings being influenced (push lens) and/or 3) allow the surroundings to be seen “in focus” in the case of presbyopia (KRESS, B. C.: “Optical waveguide combiners for AR headsets: features and limitation,” Digital Optical Technologies, Proc. of SPIE Vol. 11062, 2019). Limits for a non-perceivable deterioration in the visual acuity are specified in ATCHINSON, D. A., Noticeable, troublesome and objectionable limits of blur, Vision Research, vol. 45, no. 15, pp. 1967-1974, 2005 and ATCHINSON, D. A., Blur limits for defocus, astigmatism and trefoil, Vision research, vol. 49, no. 19, pp. 2393-2403, 2009.

In this case, the necessary optical power of the push and/or pull lenses does not necessarily extend over the entire visible region of the waveguide and—as disclosed in e.g., WO 01/95027 A2—is usually centered on the visual axis of the waveguide (FIG. 2). Here, the term “visible region” denotes that area of the waveguide which is visible and e.g., not concealed by the spectacle frame in the used state of the spectacle lens, i.e., after being fitted into a head-mounted display, for example.

For esthetic reasons, however, it would be more favorable for the push and pull lenses to extend over the entire visible region of the waveguide so that no sharp edge is visible in the field of view—both in reflection and transmission. However, if the push and pull lenses are enlarged to cover the entire visible region of the waveguide then this causes a significant center or edge thickness and a high lens-element weight, especially in the case of high dioptric values.

### SUMMARY

Against this background, the problem addressed by the disclosure is that of specifying options that allow the aforementioned disadvantages to be avoided at least in part.

This problem is solved by a spectacle lens for a head-mounted display including a first lens element, a second lens element, and a waveguide, wherein the first and second lens elements have curved surfaces.

A first aspect of the disclosure relates to a spectacle lens for a head-mounted display. The spectacle lens comprises a first lens element with a curved first lens-element surface, a second lens element with a curved second lens-element surface, and a waveguide. The waveguide is arranged in such a way between the first lens element and the second lens element that the first lens-element surface and the second lens-element surface face away from the waveguide, i.e., are arranged opposite the waveguide or point outwardly in the direction of the eye or in the direction of the surroundings.

Optionally, an output coupling element or an output coupling structure may be arranged on the waveguide. From the inside to the outside, the curvature of one of the two lens-element surfaces changes from concave to convex at least in portions. From the inside to the outside, the curvature of the other of the two lens-element surfaces changes from convex to concave at least in portions. For example, the curvature may change from convex to concave—or vice versa—if the lenses are designed in the same way as in the case of aspheric lenticular spectacle lenses.

Typically, the curvature and/or gradient of at least one of the two lens-element surfaces, particularly typically of both lens-element surfaces, can change continuously, i.e., in accordance with a continuous mathematical function.

Attention is drawn to the fact that the designation as first or second lens element, first or second lens-element surface, etc. only serves to distinguish between the two lens elements or lens-element surfaces and does not specify any specific arrangement with respect to the eye or the surroundings, unless stated otherwise. Thus, depending on a refractive error to be corrected, for example, the first lens may be arranged facing or facing away from the eye and the spectacle lens may be held in a spectacle frame with a corresponding alignment.

In other words, the waveguide is at least partially covered or enclosed by the two lens elements. Typically, the first lens element and the second lens element may completely cover the region of the waveguide visible in the used state of the spectacle lens. This may improve the esthetics. Optionally, the first and the second lens elements may cover the entire waveguide; although this cannot further improve the esthetics, this can facilitate the production of the spectacle lens.

Changing the curvature of the two lens-element surfaces from the inside to the outside means that the curvature behavior is considered in the direction of the circumferential edge or the outer limit of the lens element (outside) starting from a point at the center of the lens (inside), e.g., the center thereof or the intersection point of the optical axis or the intersection point of the visual axis of the waveguide.

Viewed differently, the surfaces of each of the two lens elements have lines of inflection.

In this case, a line of inflection should be understood as meaning the one-dimensional region, i.e., a line, of a continuous surface, i.e., the lens-element surface in this case, at which the curvature, i.e., the second derivative, changes its sign. Shape and position of this one-dimensional region, i.e., of the line, can be designed in any desired way. The line can be open or closed; changes in gradient and curvature of the line itself should typically likewise be continuous in terms of gradient and curvature along the closed line or between the ends of the open line.

For example, the line of inflection can be closed and e.g., form a circle or an oval. The shape of the line of inflection can be matched to the shape of the spectacle frame which is intended to be used with the spectacle lens. For example, the shape of the line of inflection can be designed such that the distance between the line of inflection and the outer boundary of the lens-element surface of the edged spectacle lens, i.e., of the spectacle lens matched to the spectacle frame, remains substantially the same.

By changing the curvature behavior on the lens-element surfaces, a continuous transition zone, typically a transition zone with a continuous gradient and curvature, is created for each lens element between the optically corrected region of the respective lens element and the carrier edge thereof, which is also referred to as the edge zone.

The optically corrected region should be understood to mean an optically effective region which is arranged substantially centrally on the lens-element surface and which allows the user to perceive the surroundings as exactly as possible in the used state of the head-mounted display equipped with the lens elements. To this end, this region may have an optically corrective effect, e.g., for correcting a refractive error of the user. In order thus to distinguish this region from other optically effective regions, it is referred to below as optically corrected region, independently of whether an optical correction of a refractive error actually takes place. By contrast, the edge zone substantially does not contribute to the desired optical effect and may be designed to meet cosmetic demands, e.g., depending on the spectacle frame to be used.

Typically, the transition zone may be designed to be aspheric or in the form of a free-form surface. The line of inflection, which is introduced for the transition into the transition zone, may extend at least in part—or else in full—at the boundary between the optically corrected region and the transition zone, but not in the optically corrected region itself. An aspherical surface can be understood to mean a rotationally symmetric surface, the surface of which has surface regions with deviating radii of curvature. In a broader sense, a free-form surface can be understood to mean a complex surface that can be represented, in particular, using piecewise-defined functions, in particular twice continuously differentiable piecewise-defined functions. Examples of suitable regionally defined functions are (in particular piecewise) polynomial functions (in particular polynomial splines, such as for example bicubic splines, higher-degree splines of the fourth degree or higher, or polynomial non-uniform rational B-splines (NURBS)). These should be distinguished from simple surfaces, such as e.g., spherical surfaces, aspherical surfaces, cylindrical surfaces, and toric surfaces, which are described as a circle, at least along a principal meridian. In particular, a free-form surface need not have axial symmetry and need not have point symmetry and can have different values for the mean surface power value in different regions of the surface.

The creation of the continuous transition zone brings about a reduction in the central and edge thicknesses of the lens elements and hence also a reduction in weight. At the same time, an esthetically pleasing spectacle lens can be created such that the user acceptance for wearing such spectacle lenses and head-mounted displays can be increased. These advantages are even more pronounced in the case of a continuous change in the curvature of at least one of the two lens-element surfaces.

The lens-element surface may be rotationally symmetric, and this can contribute to simpler production of the lens element. For example, the spectacle lens may be manufactured from glass or polymers.

From the inside to the outside, the lens-element surface of the lens element facing an eye in the used state of the spectacle lens can change its curvature from concave to convex at least in portions according to various exemplary embodiments. For example, the lens element facing the eye may be embodied as a pull lens.

Consequently, the lens-element surface of the lens element facing away from the eye changes from convex to concave at least in portions, as viewed from the inside to the outside. For example, the lens element facing away from the eye may be embodied as a push lens. This design allows the focus of the virtual image to be defined at any desired distance without the image of the real surroundings being influenced.

In the viewing direction of an eye, the local curvatures of the first lens element and of the second lens element may typically be in opposite senses in the used state of the spectacle lens. In other words, the spectacle lens may be designed such that a gaze of the user of the spectacle lens initially passes through a concave region of a lens-element surface, then through the waveguide and subsequently through a convex region of a lens-element surface. Alternatively, the spectacle lens may be designed such that a gaze of the user of the spectacle lens initially passes through a convex region of a lens-element surface, then through the waveguide and subsequently through a concave region of a lens-element surface. This may contribute to a reduction of aberrations.

According to further exemplary embodiments, the curvatures of the first and second lens-element surfaces may be matched to each other in such a way that aberrations of the spectacle lens are smaller than aberrations of the first and/or second lens elements on their own. For example, such aberrations might be distortion or changes in the local diopter value and/or in the local astigmatism in the direction of the spectacle lens edge.

For example, the curvatures of the first and second lens-element surfaces may be matched to one another in such a way that aberrations of the spectacle lens are no greater than 0.1 log MAR (logarithmic Minimum Angle Resolution) in an optically corrected region and/or no greater than 0.6 log MAR, typically 0.5 log MAR, in a transition zone. This corresponds to a decimal visual acuity of 0.8 for the optically corrected region and 0.25, typically 0.3, for the transition zone. In other words, the spectacle lens may be designed such that the use of the spectacle lens is accompanied by a maximum deterioration in the visual acuity of 0.1 log MAR in the optically corrected region and 0.6 log MAR in the transition zone.

Expressed differently, the first and second lens-element surfaces may be embodied in a targeted manner such that the aberrations in the edge region, known to exist in the lenticular lenses, are rendered smaller than the aberrations of a singlet lens by the combination of the first and second lens elements. That is to say, the optical effects of the edge addition may compensate one another at least in part. Limiting the aberrations in this way may have the effect of no deterioration in the visual acuity being perceptible when the spectacle lens is used. This may lead to an increase in the user acceptance for such a spectacle lens and a head-mounted display equipped therewith.

According to further exemplary embodiments, the first lens element and/or the second lens element can be embodied to correct a refractive error of a user of the spectacle lens. In other words, the spectacle lens can be matched to the user's individual vision. For example, myopia, hyperopia, astigmatism and/or presbyopia can be compensated for in the manner known from ophthalmic optics. Further apparatuses for refractive error correction can therefore be dispensed with. This may also contribute to higher user acceptance.

A further aspect of the disclosure relates to a head-mounted display having a spectacle lens according to the preceding description. Reference is made to the explanations relating to the spectacle lens, which also apply to the head-mounted display in analogous fashion. The advantages of the spectacle lens are correspondingly associated with the head-mounted display.

A further aspect of the disclosure relates to a computer-implemented method for designing a spectacle lens for a head-mounted display. Computer implemented means that at least one method step, typically multiple or all method steps, are carried out using a computer program. For example, the method can be used to design a spectacle lens in accordance with the description above.

The object of the method is to obtain a data set, e.g., in the form of a numerical or virtual representation, which describes the spectacle lens; this description is typically so comprehensive that a production of the spectacle lens on the basis of the data set is made possible.

The method includes the following method steps which, as explained in detail below, may be carried out in the specified sequence or else in a sequence that deviates from the specified sequence, and/or all or some of these method steps may be carried out simultaneously: receiving first data, e.g., in the form of a first numerical representation, for describing a first lens element with a curved first lens-element surface, receiving second data, e.g., in the form of a second numerical representation, for describing a second lens element with a curved second lens-element surface, receiving data, e.g., in the form of a third numerical representation, for describing a waveguide, e.g., its material, element thickness, etc., to be arranged in such a way between the first lens element and the second lens element that the first lens-element surface and the second lens-element surface face away from the waveguide, modeling a first optically corrected region of the first lens-element surface and optimizing the first optically corrected region for minimal aberrations on the basis of the first data, modeling and optimizing a first transition zone, which at least partially surrounds the first optically corrected region, on the basis of the first data, modeling a second optically corrected region of the second lens-element surface on the basis of the second data and optimizing the second optically corrected region for minimal aberrations and modeling and optimizing an edge zone, which at least partially surrounds the second optically corrected region, on the basis of the second data.

The first and second optical regions and the first and second transition zones are modeled and optimized in such a way that, from the inside to the outside, the curvature of one of the two lens-element surfaces changes from concave to convex at least in portions and, from the inside to the outside, the curvature of the other of the two lens-element surfaces changes from convex to concave at least in portions. Typically, the change in the gradient and curvature may be continuous. Receiving the data means that the data have been made available, e.g., by retrieval from a storage medium or input by way of an input device.

Optionally, the first and second optical regions and the first and second transition zones can be modeled and optimized in such a way that a data set for describing a spectacle lens in accordance with the description above is obtained. In this respect, reference is made to the description above. The advantages of the spectacle lens are correspondingly associated with the proposed method.

Moreover, an edge zone which adjoins the transition zone when viewed from the inside to the outside can be modeled. For example, the edge zone can be modeled together with the transition zone or modeled after the transition zone. For example, the edge zone may serve to reduce the weight of the optical device and to ensure a desired esthetic appearance.

The shaping of the edge zone may be dominated by weight reduction and dimensional stability and may require additional curving of the surface in the region of a transition zone. The optically corrected region of the lens element may typically transition continuously into the edge zone through a transition zone. In the transition zone, the optical correction decreases progressively radially to the outside. This counteracts a discontinuous visual impression in the edge region of the lens-a compromise between aberration correction and weight/dimensional stability.

The two lens-element surfaces to be embodied, for example in aspherical fashion or as a free form, can be optimized and designed iteratively. In this case, the aspherical or free-form-like profiles of the lens-element surface of the pull lens may be optimized initially only for minimal aberrations of the inner region, which has been optically corrected for the user. Subsequently, the transition zone and optionally the edge zone of the lens-element surface of the pull lens may be modeled up to the visible edge of the waveguide, e.g., according to the esthetic (center thickness, edge thickness) and mechanical (weight, stability) aspects. Finally, the aspherical or free-form-life profile of the lens-element surface of the push lens may likewise be post-optimized over the entire visible region of the waveguide, i.e., for example, the region of the optically corrected zone, of the transition zone and of the edge zone. Hence, the push asphere or push free-form surface is capable of partially compensating for the aberrations added by the transition zone of the pull lens and of optimizing the view therethrough. Typically, this should result in aberrations of no more than approx. 0.1 log MAR or 0.8 decimal visual acuity for the inner, optically corrected region. For the transition zone, the limit may be at approx. 0.6 log MAR or 0.25 decimal visual acuity.

This iterative process is likewise reversible. Thus, it may also start with the push lens design and subsequently be complemented by post-optimization of the aspherical or free-form-like profile of the lens-element surface of the pull lens. It should also be mentioned that the described modeling and optimization process for the surfaces of the push and pull lenses by accordingly differently weighted parameters can likewise be implemented not iteratively but simultaneously. Independently of the optimization sequence or type of optimization (iteratively or simultaneously), the surface shape of the edge region of one of the lens elements may typically depend on the surface shape of the other lens element, which has been optimized in view of optical, mechanical and/or esthetic aspects.

This type of optimization primarily serves to improve the view through the spectacle lens or through a head-mounted display equipped therewith, since the virtual AR image generally covers only a smaller image field in comparison with the entire field of view of the spectacles. Moreover, optimization offers the possibility of individualizing the design of the push and pull lenses, e.g., in a manner adapted to the respective refractive error of the user, to the size of the waveguide and/or to the size of the spectacle frame.

In other words, the following modeling and optimization step sequences, inter alia, may result:
a) Initially, the optically corrected region and the transition zone of the lens-element surface of the lens element facing the eye in the used state of the spectacle lens are modeled and optimized. Subsequently, the optically corrected region and the transition zone of the lens-element surface of the lens element facing away from the eye in the used state of the spectacle lens are modeled and optimized.
b) Initially, the optically corrected region and the transition zone of the lens-element surface of the lens element facing away from the eye in the used state of the spectacle lens are modeled and optimized. Subsequently, the optically corrected region and the transition zone of the lens-element surface of the lens element facing the eye in the used state of the spectacle lens are modeled and optimized.
c) The first optically corrected region and the second optically corrected region are modeled and optimized at the same time, and/or the first transition zone and the second transition zone are modeled and optimized at the same time.

A further aspect of the disclosure relates to a data processing system comprising a processor. The processor is configured such that it is capable of executing one of the computer-implemented methods, explained above, for designing a spectacle lens for a head-mounted display. Reference is made to the description of these methods. The advantages of the method are correspondingly associated with the data processing system.

In addition to the processor, the data processing system may comprise further devices, e.g., a data storage unit, an input device, an output device, etc. For example, the processor may be designed to execute the method on the basis of a computer program stored in a data storage unit.

A further aspect of the disclosure relates to a computer program which comprises commands that, when the program is executed by a computer, cause the latter to carry out any of the computer-implemented methods, explained above, for designing a spectacle lens for a head-mounted display. Reference is made to the description of these methods. The advantages of the method are correspondingly associated with the computer program.

A computer program can be understood to mean program code that is storable on a suitable medium, e.g., on a computer-readable data carrier, and/or retrievable by way of a suitable medium. Any medium suitable for storing software, for example a non-volatile memory installed in a controller, a DVD, a USB stick, a flash card or the like, can be used to store the program code. For example, the program code can be retrieved via the Internet or an Intranet or via another suitable wireless or wired network. For example, the computer program can also be transmitted by means of a data carrier signal.

Further aspects of the disclosure relate to a computer-readable data carrier with a stored computer program in accordance with the description above and to a data carrier signal for transmitting the above-described computer program.

A further aspect of the disclosure relates to a data set containing data for describing a spectacle lens in accordance with the description above, wherein the data describe the curvature of the first lens-element surface and the curvature of the second lens-element surface. Reference is made to the explanations relating to the proposed spectacle lens. The advantages of the spectacle lens are correspondingly associated with the data set.

For example, the data set may be obtained by means of the computer-implemented method, explained above, for designing a spectacle lens for a head-mounted display such that reference is made to the explanations and advantages in this respect. The data set may be stored on a suitable medium and/or transmitted by means of a data carrier signal. Furthermore, the data set may represent a numerical and/or virtual representation of the spectacle lens.

A further aspect of the disclosure relates to a method for producing a spectacle lens. The method includes the following method steps: providing a first lens element with a curved first lens-element surface, providing a second lens element with a curved second lens-element surface, providing a waveguide and arranging the waveguide in such a way between the first lens element and the second lens element that the first lens-element surface and the second lens-element surface face away from the waveguide. From the inside to the outside, the curvature of one of the two lens-element surfaces changes from concave to convex at least in portions. From the inside to the outside, the curvature of the other of the two lens-element surfaces changes from convex to concave at least in portions. Typically, the change in the gradient and curvature may be continuous. The method steps can be carried out in the specified sequence or in a different sequence.

One of the spectacle lenses, as explained above, can be produced by means of the proposed method. Reference is therefore made to the explanations given in this respect. The advantages of the spectacle lens are correspondingly associated with the production method.

The curvature of the first and/or second lens surface can be ascertained by means of one of the above-described computer-implemented methods for designing a spectacle lens for a head-mounted display. Reference is made to the relevant explanations and advantages of such a method. In this respect, the production method may follow the design method.

### BRIEF DESCRIPTION OF THE DRAWINGS

The disclosure will now be described with reference to the drawings wherein:

FIG. 1 shows an illustration regarding the use of push and pull lenses in head-mounted displays according to the related art;

FIG. 2A shows an illustration of the relationships between the optically corrected region of push and pull lenses and the visible region of the waveguide according to the related art;

FIG. 2B shows an illustration regarding push and pull lenses arranged centered on the visual axis of the waveguide, according to the related art;

FIG. 3A shows a push and pull lens design with a spherical profile according to the related art (sectional illustration);

FIG. 3B shows a push and pull lens design with an aspherical continuation including lines of inflection (punctiform in the illustrated section) on both sides for connecting the carrier edge region for reducing weight and for reducing the center and edge thicknesses (sectional view from below in half section);

FIG. 3C shows a plan view of the lens design from FIG. 3B;

FIG. 4 shows a schematic illustration of a 2-D push-pull lens combination with an optically corrected region and an edge zone for a non-axisymmetric spectacle lens contour, sagittal view;

FIG. 5A shows a schematic sectional illustration of a pull lens with an aspherical edge zone for a non-axisymmetric spectacle lens contour;

FIG. 5B shows a schematic sectional illustration of a pull lens with a conical edge zone for a non-axisymmetric spectacle lens contour;

FIG. 5C shows a schematic sectional illustration of a pull lens with an aspherical edge zone for a non-axisymmetric spectacle lens contour;

FIG. 6 shows a schematic illustration of an exemplary head-mounted display;

FIG. 7 shows a flowchart of an exemplary method for designing a spectacle lens;

FIG. 8 shows a flowchart of an exemplary method for producing a spectacle lens; and

FIG. 9 shows a schematic illustration of an exemplary data processing system.

### DETAILED DESCRIPTION OF EXEMPLARY EMBODIMENTS

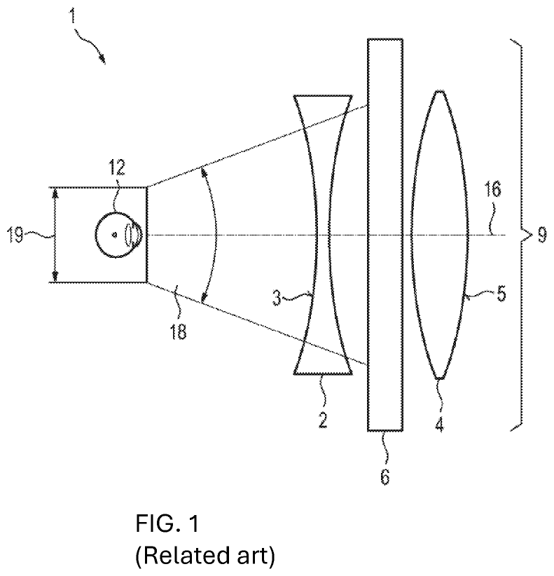

FIG. 1 shows the use of push and pull lenses in head-mounted displays according to the related art. A spectacle lens 1 of a head-mounted display 100 with a first lens element 2 and a second lens element 4 is shown. A waveguide 6 is arranged between the first lens element 2 and the second lens element 4. The first lens element 2 is in the form of a pull lens and arranged facing the eye 12 in the used state of the head-mounted display 100. The second lens element 4 is in the form of a push lens and arranged facing away from the eye 12 in the used state of the head-mounted display 100.

With their eye 12, the user of the head-mounted display 100 gazes through the spectacle lens 1 along the visual axis 16, with the field of view 18 being restricted, as illustrated in FIG. 1. In this case, the term field of view denotes, in general, the visual field of an eye, i.e., the space viewed by the eye without an eye movement. In this case, a virtual image generated by the head-mounted display 100 is correctly perceptible within the eye box 19.

Specifically, the eyebox 19 is that three-dimensional region of the light tube in the imaging beam path in which the eye pupil can move, without vignetting of the image taking place.

The first lens element 2 or pull lens is embodied as a spherical diverging lens and comprises a first lens-element surface 3, which is arranged facing away from the waveguide 6 and embodied in concave fashion throughout, i.e., arched inwardly in relation to the lens element 2 and arched away from the observer in relation to an observer of the first lens-element surface 3. As an alternative to the exemplary embodiment with two concave surfaces shown in FIG. 1, the first lens element 2 may also be a planoconcave lens element.

The first lens element 4 or push lens is embodied as a spherical converging lens and comprises a second lens-element surface 5, which is arranged facing away from the waveguide 6 and embodied in convex fashion throughout, i.e., arched outwardly in relation to the lens element 4 and arched toward the observer in relation to an observer of the second lens-element surface 5. As an alternative to the exemplary embodiment with two convex surfaces shown in FIG. 1, the second lens element 4 may also be a planoconvex lens element. Regarding the function of the first and second lens elements 3, 5, reference is made to the explanations given in the introductory part of the description.

However, the first and second lens elements 3, 5 only extend over a portion of the visible region 9 of the waveguide 6. Their optical effect is centered on the visual axis 16. This is disadvantageous inasmuch as there is an abrupt change in the optical effect at the outer boundary of the first or second lens element 3, 5, which is perceived as disadvantageous by the user. The spectacle lens 1 shown in FIG. 1 is also disadvantageous for esthetic reasons since the transition between the first or second lens element 3, 5 and the waveguide 6 is perceived to be too abrupt.

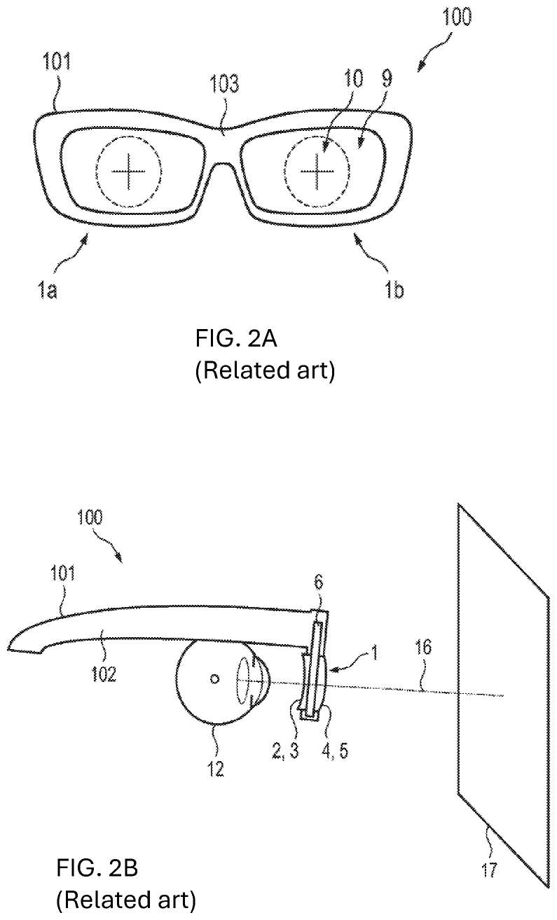

FIGS. 2A and 2B illustrate an embodiment according to the related art. A head-mounted display 100 is illustrated in a front view (FIG. 2A) and in a side view (FIG. 2B); this head-mounted display comprises a spectacle frame 101 having two earpieces 102 and enclosing two spectacle lenses 1a, 1b, which are connected to each other by way of a nosepiece 103. The circular optically corrected regions 10 of the first and second lens elements 3, 5 can be identified. The visible region 9 of the waveguide 6 extends beyond the circular, optically corrected region 10 and completely fills the spectacle lens openings in the spectacle frame 101. The head-mounted display 100 generates a virtual image in the AR image plane 17, which is observed by the eye 12 along the visual axis 16.

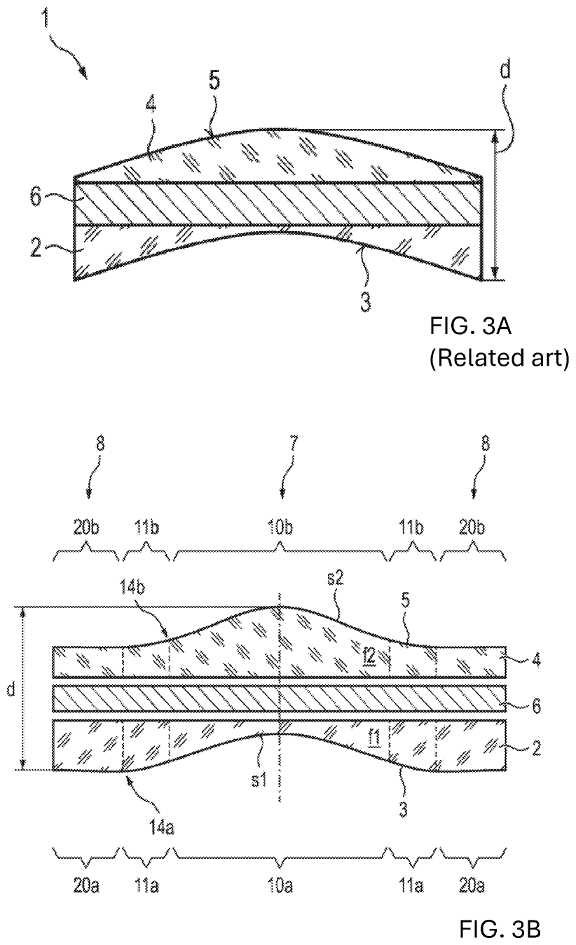

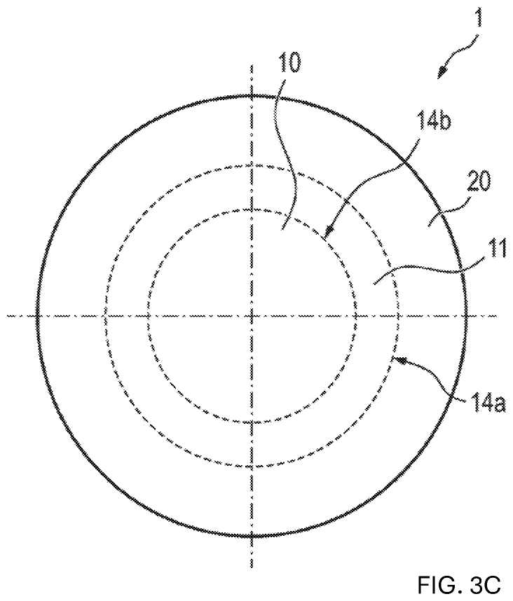

FIG. 3A shows a further spectacle lens 1 according to the related art. Like in FIGS. 1 and 2, the spectacle lens 1 also comprises a waveguide 6 which is enclosed by a spherical first lens element 2 and a spherical second lens element 4, the first and second lens element surfaces 3, 5 of which are of concave and convex design, respectively. However, the first and second lens elements 3, 5 extend over the entire waveguide 6. This is advantageous, as no sharp edges are visible in the visual field, either in reflection or in transmission. However, this is accompanied by large center and edge thicknesses and also results in a high overall thickness d of the spectacle lens 1. As a result, the spectacle lens 1 has a high weight. Moreover, its production requires relatively large amounts of material.

In order to minimize these disadvantages, a different shape—as depicted by way of example in FIGS. 3b and 3c—is proposed for the first and second lens elements 2, 4. Attention is drawn to the fact that the sectional plane shown in FIG. 3B coincides with the optical axis. The illustration in FIG. 3B arbitrarily shows a spectacle lens 1 with an axisymmetric contour, i.e., with symmetry in relation to the optical axis.

In contrast to the spectacle lens 1 in FIG. 3A, the first lens-element surface 3 and the second lens-element surface 5 each have a line of inflection 14a, 14b (punctiform in the half section) in the sectional illustration perpendicular to the two lens-element surfaces 3, 5 shown in FIG. 3B. At these lines of inflection 14a, 14b, the curvature behavior changes continuously in terms of the gradient and curvature of the lines of intersection s1, s2, which mark the abutment of one of the two lens-element surfaces 3, 5 with the associated intersection surface f1, f2. Viewed from the inside 7 to the outside 8, the line of intersection f1 changes its curvature behavior from concave to convex, while the line of intersection f2 changes its curvature behavior from convex to concave.

Considered in three dimensions, the curvature behavior of the lens-element surfaces 3, 5 changes accordingly, i.e., from the inside 7 to the outside 8, the curvature of the first lens-element surface 3 changes from concave to convex at least in portions and, from the inside 7 to the outside 8, the curvature of the second lens-element surface 5 changes from convex to concave at least in portions. The first lens-element surface 3 has a first line of inflection 14a; the second lens-element surface 5 has a second line of inflection 14b. In the exemplary embodiment, both lines of inflection 14a, 14b are closed and circular. For example, the closed line may be circular or elliptical.

When likewise considered from the inside 7 to the outside 8, the two lens-element surfaces 3, 5 have first and second optically corrected regions 10, 10b, respectively, which are circular in this exemplary embodiment. To the outside 8, the first or second optically corrected region 10, 10b is adjoined by an annular first or second transition zone 11a, 11b in this exemplary embodiment. The latter is adjoined further outward 8 by a first or second edge zone 20a, 20b, which is likewise annular in this exemplary embodiment. The respective three regions or zones of the first and second lens-element surfaces 3, 5 are arranged congruently, i.e., they are arranged one above the other when viewed parallel to the optical axis. While the two optically effective regions 10a, 10b are optically ideally corrected and the two edge zones 20a, 20b are not optically corrected, the two transition regions 11a, 11b represent a compromise between carrier edge requirements and optical requirements.

The first line of inflection 14a marks the transition between edge zone 20a, 20b and transition zone 11a, 11b, while the second line of inflection 14b marks the transition between the transition zone 11a, 11b and the optically corrected region 10a, 10b.

The proposed design of the lens-element surfaces 3, 5 leads to a significant reduction in the thicknesses at the edge and center, and in the overall thickness d of the spectacle lens 1, in comparison with the spectacle lens 1 according to FIG. 3A. With the spectacle lens 1 of FIGS. 3B and 3C, it is possible to achieve both a weight reduction and an improvement in the esthetics.

Moreover, the lens-element surfaces 3, 5 of this exemplary embodiment are curved such that aberrations in the edge region, e.g., distortion, changes in the local diopter value, changes in the local astigmatism toward the edge, are at least partially compensated for, i.e., the aberrations of the spectacle lens 1 can be smaller than the aberrations of the first and/or second lens element 3, 5 alone.

FIG. 3C shows a corresponding plan view of the spectacle lens 1 from FIG. 3B with plotted lines of inflection 14a, 14b. The lines of inflection 14a, 14b are circular and closed on account of the symmetry of the spectacle lens 1. The individual edging to the frame has not been illustrated. For example, this contour might have been produced by milling.

FIG. 4 depicts a further exemplary embodiment of a spectacle lens 1, which is observed by an eye 12. Reference sign 13 denotes the primary gaze direction of the eye 12, i.e., the viewing direction parallel to the ground, such that the viewing lines are aligned parallel to the horizon when viewing into the distance. The sagittal view of the eye 12 is shown. The downward visual field for the one viewing direction described is illustrated.

The spectacle lens 1 comprises a 2D push-pull lens combination for transmission with a basic setup as described in relation to FIG. 3B, and so reference is made to the explanations in that respect. The lens-element surfaces 3, 5 were optimized for the smallest possible aberrations. The optimization target of 0.1 log MAR is observed within the ray height 15 of +/−23 mm, i.e., within the optically corrected region 10. An aberration of no more than 0.6 log MAR is permitted in the transition zone 11.

Table 1 shows the correction profile over the various ray heights 15 in diopters and log MAR. Moreover, the positions of the lines of inflection 14a, 14b can clearly be identified on the curved lens-element surfaces 3, 5.

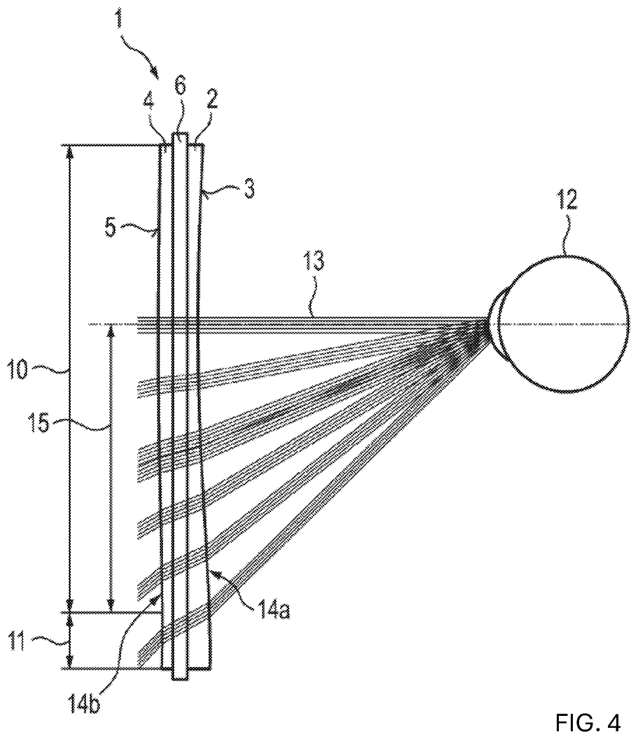

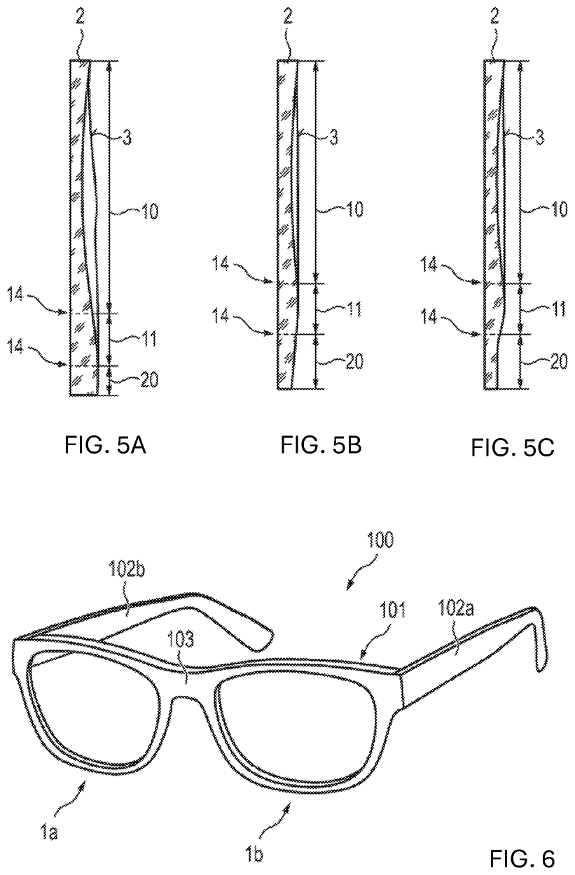

TABLE 1
Correction profile over the
different ray heights of the lens
design according to FIG. 5.

| Ray height | Diopter | MAR | |
|---|---|---|---|
| [mm] | [l/m] | [l/V] | logMAR |
| 0 | 0.00 | 1.00 | 0.00 |
| 1 | 0.00 | 1.00 | 0.00 |
| 2 | 0.01 | 1.01 | 0.00 |
| 3 | 0.02 | 1.02 | 0.01 |
| 4 | 0.03 | 1.04 | 0.02 |
| 5 | 0.05 | 1.06 | 0.03 |
| 6 | 0.06 | 1.09 | 0.04 |
| 7 | 0.08 | 1.12 | 0.05 |
| 8 | 0.10 | 1.15 | 0.06 |
| 9 | 0.12 | 1.18 | 0.07 |
| 10 | 0.14 | 1.21 | 0.08 |
| 11 | 0.15 | 1.23 | 0.09 |
| 12 | 0.16 | 1.25 | 0.10 |
| 13 | 0.17 | 1.26 | 0.10 |
| 14 | 0.17 | 1.27 | 0.10 |
| 15 | 0.17 | 1.27 | 0.10 |
| 16 | 0.16 | 1.26 | 0.10 |
| 17 | 0.15 | 1.24 | 0.09 |
| 18 | 0.14 | 1.22 | 0.09 |
| 19 | 0.13 | 1.20 | 0.08 |
| 20 | 0.12 | 1.19 | 0.07 |
| 21 | 0.12 | 1.19 | 0.07 |
| 22 | 0.13 | 1.20 | 0.08 |
| 23 | 0.16 | 1.25 | 0.10 |
| 24 | 0.21 | 1.33 | 0.12 |
| 25 | 0.27 | 1.45 | 0.16 |
| 26 | 0.33 | 1.58 | 0.20 |
| 27 | 0.38 | 1.68 | 0.23 |
| 28 | 0.36 | 1.64 | 0.21 |
| 29 | 0.21 | 1.34 | 0.13 |
| 30 | −0.08 | 0.90 | −0.05 |
| 31 | −0.42 | 0.56 | −0.25 |
| 32 | −0.40 | 0.57 | −0.24 |
| 33 | 1.00 | 4.01 | 0.60 |

The bold line marks the transition between optically corrected region and transition zone.

Overall, this exemplary embodiment achieved a reduction in edge thickness by approx. 1.2 mm in comparison with a lens design according to the related art (see FIG. 3A) without a carrier edge.

FIGS. 5A to 5C illustrate three further variants of different transition zones 11 and edge zones 20 in the form of carrier edge aspheres for a pull lens, in each case in a sectional illustration. The sectional plane is coincident with the optical axis in each case and is azimuthally oriented such that the transition between transition zone 11 and edge zone 20 is clearly visible. The hatching indicates the sectional plane. The non-cut part of the lens element 2 is located behind the sectional plane from the viewing direction.

Like FIG. 4, FIG. 5A shows a pull lens with an aspherical transition zone 11, which is continuous in terms of gradient and curvature and which connects the optically corrected region 10 to the edge zone 20. The lens-element surface 3 is described using a single asphere equation. In the exemplary embodiment, the pull lens is made of MR8 material with a density of 1.3 g/cm³, resulting in a mass of 4.64 g.

FIG. 5B shows a pull lens with a conically tapering transition zone 11, which is continuous in terms of gradient and curvature and which connects the optically corrected region 10 to the edge zone 20. Its mass is 3.58 g.

The pull lens of FIG. 5C likewise has a continuous transition zone 11 with a continuous gradient and curvature but, as a variant of the exemplary embodiment of FIG. 5A, the lens surface 3 is described in piecewise fashion by two asphere equations which are continuous in terms of gradient and curvature at the line of inflection 14. In FIG. 5C, the edge zone 20 is designed such that it extends toward the outermost edge in a manner that is virtually flat and parallel to the waveguide surface. In this respect, it should also be noted that, for a free-form surface, it is optionally possible to use no descriptive formula at all, but instead only radial sagittal heights of the surface, which is continuous in terms of gradient and curvature everywhere. The mass of the pull lens according to FIG. 5C is 3.35 g.

In the exemplary embodiments according to FIGS. 5B and 5C, the focus of the optimization lay in reducing the weight and thickness such that the optically corrected region 10, within which the optimization criterion of 0.1 log MAR is observed, is slightly reduced in size. In addition, the optimization target for the transition zone 11 of 0.6 log MAR was also loosened in favor of weight minimization here. In return, a further reduction in weight by 1.06 g (FIG. 5B) or 1.29 g (FIG. 5C) could be achieved in comparison with the pull lens according to FIG. 5A. Depending on the material used and depending on the density thereof, there is a greater or lesser reduction in the weight depending on the attainable reduction in volume.

FIG. 6 schematically illustrates an exemplary head-mounted display 100. The head-mounted display 100 comprises two spectacle lenses 1a, 1b which are held by a spectacle frame 101 with two earpieces 102a, 102b. At least one of the spectacle lenses 1a, 1b—typically both spectacle lenses 1a, 1b—is characterized in that, from the inside 7 to the outside 8, the curvature of its lens-element surface 3, 5 changes from concave to convex or from convex to concave at least in portions. For example, the spectacle lenses 1a, 1b can be designed as shown in FIG. 3B, 4, or 5A to 5C and explained in the associated description.

The spectacle lenses 1a, 1b are embodied to generate a virtual image of an initial image displayed by means of a display, as described below. Optionally, only one of the spectacle lenses 1a, 1b may also be embodied as well to generate a virtual image, while the other spectacle lens 1a, 1b may be a conventional spectacle lens without the option of generating a virtual image.

Displays (not illustrated in FIG. 6) are arranged in the earpieces 102a, 102b and display original images that are intended to be imaged onto the retina of the user of the head-mounted display 100 by means of an imaging optics unit of the head-mounted display 100. In the present exemplary embodiment, the imaging optics unit of the head-mounted display 100 is formed by the spectacle lenses 1a, 1b, which each comprise a waveguide 6. However, the imaging optics unit may also comprise optical elements which are outside of the spectacle lenses 1a, 1b and for example may be arranged between the earpieces 102a, 102b and the spectacle lenses 1a, 1b. The replication and distribution of the projector exit pupil such that the desired eyebox is created are also important for the function of the head-mounted display 100 since otherwise image information would only be visible in one exact viewing direction and relative position of the eye with respect to the waveguide.

The spectacle lenses 1a, 1b of the head-mounted display 100 each are a part of, or form, a light-guiding arrangement of the head-mounted display 100. Each light-guiding arrangement is assigned a display on which the original image can be displayed. Each light-guiding arrangement comprises a waveguide 6 comprising an optical waveguide entrance surface and an optical waveguide exit surface. A beam emanating from the original image displayed on the display enters the waveguide 6 via the optical waveguide entrance surface and in the waveguide is reflected multiple times off a number of reflective surfaces and guided by means of these reflections to a transparent or at least partly transparent output coupling structure. In this case, the geometry and the arrangement of the reflective surfaces are chosen such that at the reflective surfaces total-internal reflection takes place at the interface between the respective spectacle lens 1a, 1b and the surrounding medium, generally air.

With the aid of the output coupling structure, for example embodied as a reflective Fresnel structure or as multiple partly transmissive mirrors or diffraction gratings, the beam is finally output coupled through the optical waveguide exit surface in the direction of the eye 12 and focused on the retina by the eye 12. Since light is guided internally in the spectacle lens 1a, 1b by total-internal reflection, and the output coupling structure is embodied as at least partly transparent, the view of the surroundings is not impeded or only minimally impeded.

Alternatively, the waveguide 6 may be configured such that reflection does not take place by means of total-internal reflection. In this case, the waveguide 6 comprises reflective coatings, but the coatings are chosen as far as possible such that they have an angularly selective effect and thus block light passing through the waveguide 6 from the surroundings as little as possible.

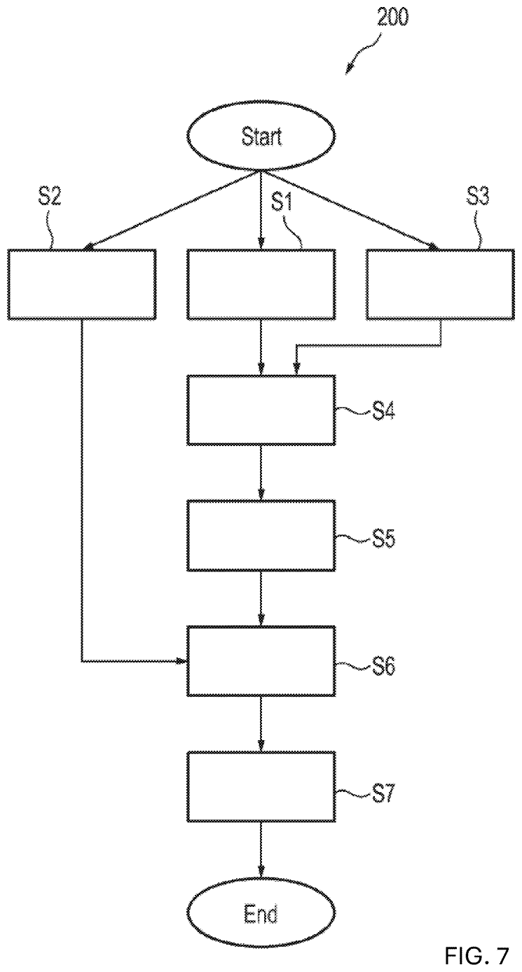

FIG. 7 shows a flowchart of an exemplary method 200 for designing a spectacle lens 1, 1a, 1b for a head-mounted display 100. For example, the method 200 may be carried out by means of the data processing system 400 which is depicted schematically in FIG. 9 and comprises a data storage unit 402, an input device 403, e.g., in the form of a keyboard, and an output device 404, e.g., in the form of a display, and a processor 401. The processor 401 is operatively signal-connected to the data storage unit 402, the input device 403 and the output device 404.

After the start of the method 200, first data are received for describing a first lens element 2 with a curved first lens-element surface 3 (method step S1), second data are received for describing a second lens element 4 with a curved second lens-element surface 5 (method step S2), and data are received for describing a waveguide 6 to be arranged in such a way between the first lens element 2 and the second lens element 4 that the first lens-element surface 3 and the second lens-element surface 5 are arranged so as to face away from the waveguide 6 (method step S3). Method steps S1, S2, S3 may be carried out simultaneously, with a time overlap or successively in any desired sequence. To receive the data, these may for example be retrieved from a data storage unit 402 or input by way of an input device 403 or transferred to the processor 401 of the data processing system 400.

The subsequent method steps S4 to S7 may be performed by means of the processor 401, for example on the basis of instructions or a code programmed into the processor 401 in accordance with one or more routines. Method steps S4 to S7 serve to model and optimize the lens-element surfaces 3, 5 of the first and second lens elements 2, 4 of the spectacle lens 1, 1a, 1b.

In method step S4, the first optically corrected region 10a of the first lens-element surface 3 is modeled on the basis of the first data and taking account of the data for describing a waveguide 6 and is optimized for minimal aberrations. In this case, to optimize for minimal aberrations means that a limit value for the aberrations, which must not be exceeded, is specified. In other words, a lens-element surface which does not exceed the specified limit value for the aberrations is considered to be optimized for minimal aberrations. In this exemplary embodiment, the lens-element surface 3 of a pull lens, for example of the pull lens 2 shown in FIG. 3B, is optimized as first lens-element surface 3.

Subsequently, a first transition zone 11a of the first lens-element surface 3 is modeled and optimized, likewise on the basis of the first data, in method step S5. In this exemplary embodiment, the first transition zone 11a completely surrounds the first optically corrected region 10a. At least that region of the first transition zone 11a which covers the visible region 9 of the waveguide 6 is optimized. The optimization may be implemented according to a specifiable esthetic and/or mechanical aspects and, for example, have the aim of minimizing a center thickness, minimizing an edge thickness, minimizing a volume or weight and/or of maximizing a rigidity, e.g., for avoiding fractures or cracks, or stiffness, e.g., for avoiding deformations. The optimization may also be implemented in view of several of the aforementioned aspects, for example by virtue of specifying limits for one or more of the aspects that must not be exceeded or must be reached as a minimum.

In method step S6, the second optically corrected region 10b of the second lens-element surface 5 is modeled on the basis of the second data and taking account of the data for describing a waveguide 6 and is optimized for minimal aberrations. In this exemplary embodiment, the lens-element surface 5 of a push lens, for example of the push lens 4 shown in FIG. 3B, is optimized as second lens-element surface 5.

A second edge zone 11b of the second lens-element surface 5 is modeled and optimized, likewise on the basis of the second data, in method step S7. The second optically corrected region 10b and the second transition zone 11b can be optimized in a manner analogous to the first optically corrected region 10a or the first transition zone 11a.

The first and second optical regions 10a, 10b and the first and second transition zones 11a, 11b are modeled and optimized in such a way that, from the inside 7 to the outside 8, the curvature of the first lens-element surface 3 changes from concave to convex at least in portions and, from the inside to the outside, the curvature of the second lens-element surface 5 changes from convex to concave at least in portions.

The first and second optical regions 10a, 10b and of the first and second transition zones 11a, 11b are modeled and optimized in such a way that the aberrations for the optically corrected region 10 of the spectacle lens 1, 1a, 1b are no more than approx. 0.1 log MAR or 0.8 decimal visual acuity. For the transition zone 11, this limit is approx. 0.6 log MAR or 0.25 decimal visual acuity.

The method 200 ends with method step S7, and it is possible to output the data for describing the modeled and optimized first and second lens-element surfaces 3, 5 in the form of a data set, for example by means of the output device 404 of the data processing system 400. Alternatively, the data set obtained can be stored on a memory medium and/or transmitted to an apparatus for machining spectacle lenses such that the lens-element surfaces 3, 5 can be embodied in accordance with the data set. Subsequently, it is possible to produce a spectacle lens 1, 1a, 1b with correspondingly embodied lens elements 2, 4.

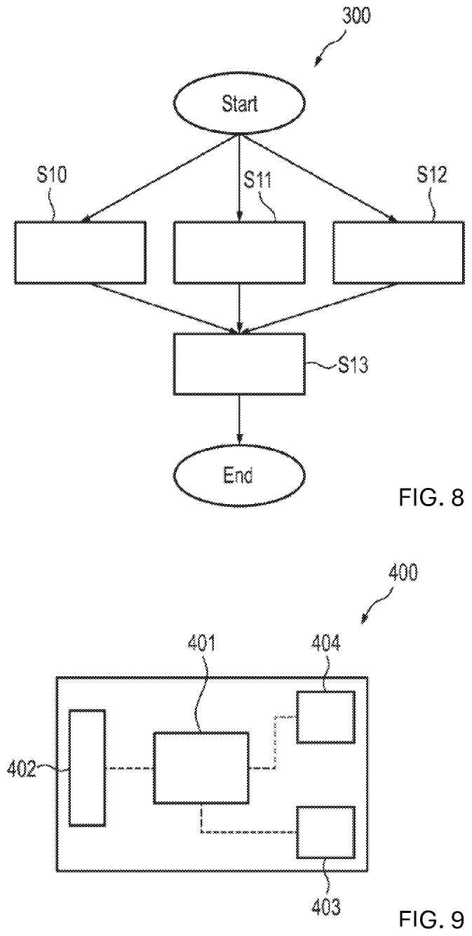

FIG. 8 shows a flowchart of a method 300 for producing a spectacle lens 1, 1a, 1b, for example for producing a spectacle lens 1, 1a, 1b as described with reference to FIGS. 3B, 4, and 5A to 5C.

Initially, a first lens element 2 with a curved first lens-element surface 3 (method step S10), a second lens element 4 with a curved second lens-element surface 5 (method step S11) and a waveguide 6 (method step S11) are provided. Method steps S10, S11, S12 may be carried out simultaneously, with a time overlap or successively in any desired sequence.

From the inside 7 to the outside 8, the curvature of the first lens-element surface 3 changes from concave to convex at least in portions, while, from the inside 7 to the outside 8, the curvature of the second lens-element surface 5 changes from convex to concave at least in portions. For example, the curvatures of the two lens-element surfaces 3, 5 may be described by means of a data set which was obtained by means of the above-described method 200 for designing a spectacle lens 1, 1a, 1b.

In method step S13, the waveguide 6 is arranged in such a way between the first lens element 2 and the second lens element 4 that the first lens-element surface 3 and the second lens-element surface 5 face away from the waveguide.

The drawings are not necessarily accurate in every detail and to scale and can be presented in enlarged or reduced form to provide better clarity. For this reason, functional details disclosed here should not be understood to be limiting, but merely to be an illustrative basis that gives guidance to a person skilled in this technical field for using the present disclosure in various ways.

The expression “and/or” used here, when it is used in a series of two or more elements, means that any of the elements listed can be used alone, or any combination of two or more of the elements listed can be used.

It is understood that other exemplary embodiments may be used, and structural or logical modifications may be undertaken without departing from the scope of protection of the present disclosure. Therefore, the present description should not be considered to be limiting and the scope of protection of the present disclosure is defined by the attached claims.

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

### LIST OF REFERENCE SIGNS

1, 1a, 1b Spectacle lens
2 First lens element
3 First lens-element surface
4 Second lens element
5 Second lens-element surface
6 Waveguide
7 Inside
8 Outside
9 Visible region
10 Optically corrected region
10a First optically corrected region
10b Second optically corrected region
11 Transition zone
11a First transition zone
11b Second transition zone
12 Eye
13 Primary gaze direction
14 Line of inflection
14a First line of inflection
14b Second line of inflection
15 Ray height
16 Visual axis
17 AR image plane
18 Field of view
19 Eye box
20 Edge zone
20a First edge zone
20b Second edge zone
100 Head-mounted display
101 Spectacle frame
102, 102a, 102b Earpiece
103 Nosepiece
200 Method
300 Method
400 Data processing system
401 Processor
402 Data storage unit
403 Input device
404 Output device
S1 Receiving first data for describing a first lens element with a curved first lens-element surface
S2 Receiving second data for describing a second lens element with a curved second lens-element surface
S3 Receiving data for describing a waveguide to be arranged in such a way between the first lens element and the second lens element that the first lens-element surface and the second lens-element surface face away from the waveguide
S4 Modeling a first optically corrected region of the first lens-element surface and optimizing the first optically corrected region for minimal aberrations on the basis of the first data
S5 Modeling and optimizing a first edge zone, which at least partially surrounds the first optically corrected region, on the basis of the first data
S6 Modeling a second optically corrected region of the second lens-element surface and optimizing the second optically corrected region for minimal aberrations on the basis of the second data
S7 Modeling and optimizing a second edge zone, which at least partially surrounds the second optically corrected region, on the basis of the second data
S10 Providing a first lens element with a curved first lens-element surface
S11 Providing a second lens element with a curved second lens-element surface
S12 Providing a waveguide
S13 Arranging the waveguide in such a way between the first lens element and the second lens element that the first lens-element surface and the second lens-element surface face away from the waveguide
d Overall thickness of the spectacle lens
f1, f2 Intersection surface
s1, s2 Line of intersection

1. A spectacle lens for a head-mounted display, the spectacle lens comprising:
at least one first lens element with a curved first lens-element surface;
at least one second lens element with a curved second lens-element surface; and
at least one waveguide which is arranged in such a way between the first lens element and the second lens element that the first lens-element surface and the second lens-element surface face away from the waveguide,
wherein, from an inside to an outside, the curvature of one of the two lens-element surfaces changes from concave to convex at least in portions, and, from the inside to the outside, the curvature of the other of the two lens-element surfaces changes from convex to concave at least in portions.

2. The spectacle lens as claimed in claim 1, wherein the curvature and/or gradient of at least one of the two lens-element surfaces changes continuously.

3. The spectacle lens as claimed in claim 1, wherein the first lens element and the second lens element completely cover a region of the waveguide that is visible in the used state of the spectacle lens.

4. The spectacle lens as claimed in claim 1, wherein, from the inside to the outside, the lens-element surface of the lens element facing an eye in the used state of the spectacle lens changes its curvature from concave to convex at least in portions.

5. The spectacle lens as claimed in claim 1, wherein the curvatures of the first and second lens-element surfaces are matched to each other in such a way that aberrations of the spectacle lens are smaller than aberrations of the first and/or second lens elements on their own.

6. The spectacle lens as claimed in claim 1, wherein the curvatures of the first and second lens-element surfaces are matched to each other in such a way that aberrations of the spectacle lens are no greater than 0.1 log MAR in an optically corrected region and/or no greater than 0.5 log MAR in a transition zone.

7. The spectacle lens as claimed in claim 1, wherein the first lens element and/or the second lens element are embodied to correct a refractive error of a user of the spectacle lens.

8. A head-mounted display having at least one spectacle lens as claimed in claim 1.

9. A computer-implemented method for designing a spectacle lens for a head-mounted display, the method comprising:
S1: receiving first data for describing at least one first lens element with a curved first lens-element surface;
S2: receiving second data for describing at least one second lens element with a curved second lens-element surface;
S3: receiving data for describing at least one waveguide to be arranged in such a way between the first lens element and the second lens element that the first lens-element surface and the second lens-element surface face away from the waveguide;
S4: modeling at least one first optically corrected region of the first lens-element surface and optimizing the first optically corrected region for minimal aberrations on the basis of the first data;
S5: modeling and optimizing at least one first transition zone, which at least partially surrounds the first optically corrected region, on the basis of the first data;
S6: modeling at least one second optically corrected region of the second lens-element surface and optimizing the second optically corrected region for minimal aberrations on the basis of the second data; and
S7: modeling and optimizing at least one second transition zone, which at least partially surrounds the second optically corrected region, on the basis of the second data,
wherein the first and second optical regions and the first and second transition zones are modeled and optimized in such a way that, from an inside to an outside, the curvature of one of the two lens-element surfaces changes from concave to convex at least in portions and, from the inside to the outside, the curvature of the other of the two lens-element surfaces changes from convex to concave at least in portions.

10. The method as claimed in claim 9, wherein the optically corrected region and the transition zone of the lens-element surface of the lens element facing an eye in the used state of the spectacle lens are modeled and optimized first, and the optically corrected region and the transition zone of the lens-element surface of the lens element facing away from the eye in the used state of the spectacle lens are subsequently modeled and optimized.

11. The method as claimed in claim 9, wherein the optically corrected region and the transition zone of the lens-element surface of the lens element facing away from an eye in the used state of the spectacle lens are modeled and optimized first, and the optically corrected region and the transition zone of the lens-element surface of the lens element facing the eye in the used state of the spectacle lens are subsequently modeled and optimized.

12. The method as claimed in claim 9, wherein the first optically corrected region and the second optically corrected region are modeled and optimized at the same time and/or wherein the first transition zone and the second transition zone are modeled and optimized at the same time.

13. A data processing system, comprising at least one processor configured to carry out a method as claimed in claim 9.

14. A computer program comprising commands that, upon execution of the program by a computer, cause the latter to carry out a method as claimed in claim 9.

15. A data set containing data for describing at least one spectacle lens as claimed in claim 1, wherein the data describe the curvature of the first lens-element surface and the curvature of the second lens-element surface.

16. A method for producing at least one spectacle lens, the method comprising:
S10: providing at least one first lens element with a curved first lens-element surface;
S11: providing at least one second lens element with a curved second lens-element surface;
S12: providing at least one waveguide; and
S13: arranging the waveguide in such a way between the first lens element and the second lens element that the first lens-element surface and the second lens-element surface face away from the waveguide,
wherein, from an inside to an outside, the curvature of one of the two lens-element surfaces changes from concave to convex at least in portions, and, from the inside to the outside, the curvature of the other of the two lens-element surfaces changes from convex to concave at least in portions.
